(19) United States
(12) Patent Application Publication
(10) Pub. No.: US 2004/0205406 A1
(43) Pub. Date: Oct. 14, 2004

(54) Automatic test system for testing remote target applications on a communication network

(76) Inventors: Marappa Kaliappan, Bangalore (IN); Narayana Paniker Sathish, Bangalore (IN); Hasan Shastry Ravi Kumar, Bangalore (IN)

Correspondence Address: FROMMER LAWRENCE & HAUG, 745 FIFTH AVENUE- 10TH FL., NEW YORK, NY, 10151, US

(21) Appl. No.: 09/853,324

(22) Filed: May 10, 2001

(30) Foreign Application Priority Data
May 12, 2000 (IN) 510/DEL/2000

(51) Int. Cl. G06F 11/22; G06F 9/44

(52) U.S. Cl. 714/31; 717/124

(57) ABSTRACT

This invention relates to an automated test system for the remote testing of applications and devices especially in dynamic environments. It provides for the automation of the testing process and for functional independence at every level of the process. The invention is particularly suited for remote testing over a network such as the internet. To achieve its purpose, the invention provides a test generation means for generating the tests and executing the testing, which is connected to a data storage means contains information about testable items and test scenarios for the testable items, as well as the results of testing. The image builder means provides a centralized image building facility for converting the tests into an executable form.

### FIELD OF THE INVENTION

This invention relates to an automatic test system for testing remote target applications on a communication network.

### BACKGROUND OF THE INVENTION

The known test systems, which have been developed and are currently in operation, have a tedious activity. When an application is to be tested, the test program has to be written for that application. The said test program might be bundled with the application or provided separately. However, the test program requires all necessary hardware and software to be available at the site of testing. Secondly, in an environment like home networking where the system configuration changes constantly, the understanding of the environment, simulating the environment and the testing is a very difficult activity.

In network systems, the software for testing the application can be downloaded through the network. However, the problem regarding the interdependence of various components of the testing process such as the tools for building the test image, identifying and recreating the configuration details, generation of reports etc. and their dependence on the hardware and software environment remains. This problem becomes particularly severe in situations where the environment is dynamic, such as in a home network.

The existing test systems require either a standard configuration of the ‘system under test’ along with the details of the various objects and their interfaces or require the user to provide such information. The test scenario, test cases and test programs are generated from this information in order to perform the testing. This can become a very cumbersome and time-consuming activity, if the details are to be provided by the user. In situations of dynamically changing environment, like the home networking, this is invariably the case.

U.S. Pat. No. 6,002,869 describes a system and method for automatically testing software program in a defined static environment on a fixed platform. Similarly, U.S. Pat. No. 5,964,891 describes a diagnostic system for distributed data access network system in which each individual system in the network is on a fixed platform and has a static defined environment. Both these patents do not address the issues relating to dynamic platforms and dynamically changing environment situations.

### THE OBJECT AND SUMMARY OF THE INVENTION

The object of this invention is to provide an automatic test system for testing remote target applications on any communication network especially suited for dynamic platforms operating in dynamically changing environments in a simple and effective manner.

To achieve the said objective, this invention provides an automatic test system for testing remote target applications on a communication network is comprising:

test generation means for executing the testing,

the said means is connected to the following elements through the said communication network:

a. a data storage means for holding the information about the testable items, the scenarios for those testable items and the results of the testing performed,

b. an image builder means for providing a centralize image building facility, and

c. a target application executing on a target device

The said elements are identified with an IP-address

The said test generation means, data storage means, image builder means and target applications are software means.

The test generation means, data storage means and an image builder means are executed either on a single computing system or on a plurality of computing systems

The said test generation means contains reflection objects for downloading to said target application through said communication network for obtaining meta-information in respect of target application.

The said target application includes a downloading means for installing reflection objects received from said test generation means.

The said target application on target device contains reflection objects for downloading meta-information to said test generation means through said communication network.

The said target application operates under an environment which supports reflection viz. the Aperios operating system (Sony's Realtime OS) or is in Java.

The said test generation means also includes a means for generating test cases independently of API or methods for which the test cases are generated.

The said test generation means further comprises a configuration module, test design module, test driver module, test execution module and a report module, all connected to the said data storage means through said network.

The configuration module is a software executing on a computing system, which obtains information on test techniques, object details and data type details from the user for defining the test cases.

The test design module is a software executing on a computing system which provides a scenario creation framework for creating test scenarios and the information stored in said data storage means.

The test driver module is a software executing on a computing system, which automatically generates the test programs in a description language using the test scenario provided by the said test design module and the information in said data storage means.

The test execution module loads the image created by the said image builder module on said target application and monitors and controls the execution of image on said target application.

The image builder means is a software executing on a computing system, which converts the test program received from the said test driver module in description language to an image form suitable for loading and executing on the said target application.

The said report module is a software executing on a computing system for generating reports from the results of the testing on the target application, which are stored in the said data storage means

The said data storage means is a software executing on a computing system for storing information relating to test scenario, test technique, object details, results of tests and incorporates object serialization means in order to improve time for execution and improve security.

The said test generation means may be developed in Java in order to make it hardware and software independent and the test program generated is in DL (description language). The said description language may be Standard Description Language (SDL), which is converted by an appropriate language code converter to the desired test language.

The said code converter to convert the description language test program to the desired language test program is provided either at test driver module of the said test generation means or at the image builder means.

The said data storage means is a server and may be connected through ODBC/JDBC so as not to depend on any particular database, the said server may also be developed in Java in order to it hardware and software independent using object serialization for communication.

The image builder means includes an appropriate compiler and linker to generate an executable data image.

The said test generation means may further includes a means for simultaneously testing a plurality of target applications at one location or at multiple locations.

A fire-wall is either provided between said test generation means and said communication network or between the said communication network and said target applications or at both places for access control of communication.

The said communication network is comprising LAN, IEEE 1394 network or internet, wireless communication network, FTTH (Fiber To The Home), CATV, or xDigital Subscriber Line (xDSL).

The target application is a set of software which nay or may not include operating system and the said target device is used for running one or more target applications.

A method for testing remote target applications is comprising the steps of:

obtaining meta-information details of the target application,

checking the said meta-information against the stored meta-information,

updating the stored meta-information in case of discrepancy or absence of the obtained meta-information,

automatically generating test cases based on said meta-information,

adding or modifying the said test cases by user input,

automatically or manually generating test scenario and test program from the said test cases,

building the test image from the said test program,

downloading said test image to said target application for testing,

getting information from the user (test engineer) with regard to the order of execution, repetition and resetting of target application,

automatically testing the target application,

generating the reports from the test results in a required format.

The meta-information details of the target application are obtained using the reflection principle either by the use of reflection object bundled with the target application or by downloading the reflection object to the target application.

The test scenarios, test programs and test image are generated using object serialization in order to improve security of data communication over the network as well as to improve the utilization of resources in the network in order to reduce time for execution.

The said test programs are generated independent of the API or the method for which they are applicable.

A method wherein the said test program is generated by:

providing the framework to define the test scenarios using said meta-information,

generating different possible test cases automatically using said test scenarios,

generating the test program in a description language using said test scenarios and test cases.

The execution of the test programs is conducted using the order of execution, the repetition, the requirement for resetting and batch information by user input.

The reports are generated for the specified test scenarios.

The solution is provided to a service station for testing the target application or the said service station is able to use the said automatic test system through a terminal provided at the service station.

A plurality of target applications can be simultaneously tested either at one location or at multiple locations.

### BRIEF DESCRIPTION OF DRAWINGS

The invention will now be described with reference to the accompanying drawings.

FIG. 1 shows the block diagram of automatic test system for testing remote target applications on a communication network, according to this invention.

FIG. 2 shows the detailed block diagram of the automatic test system according to this invention.

FIG. 3 shows an embodiment of this invention on a single computing system

FIG. 4 shows an embodiment of this invention on a plurality of computing systems. FIGS. 5a, 5b, 5c & 5d show the functional flow diagram of target application testing using automatic test system.

FIGS. 6a & 6b show the functional flow diagram of test scenario generation and test case generation respectively.

FIG. 7 shows an example of the use of the automatic test system for a home network system using a DTV.

### DETAILED DESCRIPTION OF THE DRAWINGS

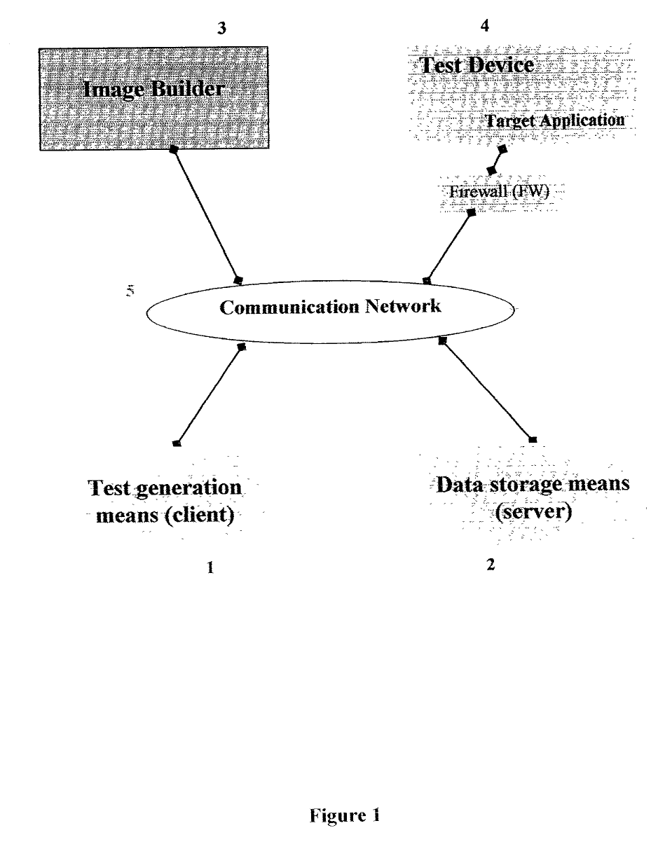

Referring to the drawings, in FIG. 1, reference numeral (5) shows the internet and the reference numerals (1), (2), (3) and (4) show the test generation means (client), data storage means (server), the image builder means and the target applications connected to the said internet (5). The firewall (FW) may either be connected between test generation means (1) and internet (5) or between the internet (5) and the target applications (4) for security reasons or at both the ends.

The test generation means (1) may be developed in Java in order to make it hardware and software independent and the test program generated is in DL (description language). The said data storage means (2) is a server and may be connected through ODBC/JDBC so as not to depend on any particular database, the said server may also be developed in Java in order to make it hardware and software independent using object serialization for communication.

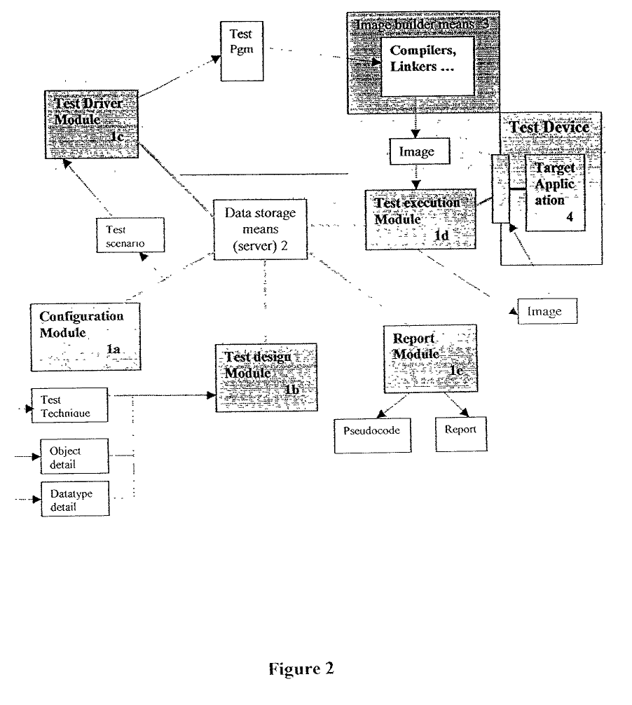

In FIG. 2, the test generation means (1) includes a configuration module (1a), test design module (1b), test driver module (1c), test execution module (1d) and report module (1e), all connected to the data storage means (2) through internet (5). The reference numeral (3) shows the image building means having compiler, linker etc. for building the image. The said image is transferred to the target application (4) through the test execution module (1d) for testing.

To start automatic test system, the user obtains the information regarding test techniques, object details and data-type details from the data storage means (2) and feeds to the configuration module (1a) of the test generation means (1) consisting of modules (1a, 1b, 1c, 1d & 1e). The automatic test system can also be pre-loaded with these information. Once the system is configured, the details will be used for all later testing activities.

The configuration module (1a) in the test generation means (1) downloads reflection object (not shown) to the target application (4) in order to collect meta-information. The meta-information is supplied back to the configuration module (1a), which then checks the meta-information with the data stored in the data storage means (2). In case of mis-match, the configuration module (1a) updates the data in the data storage means (2).

The test design module (1b) provides framework to create the test scenarios (TS) with the help of data obtained from the data storage means (2) using the information supplied by the user, as well as the information obtained from the target application (4). These test scenarios (TS) are used by the test driver module (1c) to generate different possible test cases automatically. The said test driver module (1c) further uses the said test cases to generate the test programs in a description language. The code converter (not shown), which is provided either at the test driver module (1c) or at the image builder means (3) converts the said description language to the desired language test programs. The said test programs are sent to the image builder means (3), which has the appropriate compiler and the linker to generate the image. Once the image is built, the image builder means (3) informs the test execution module (1d), which in turn downloads the image to the target application (4) at the request of the user. The said test execution module (1d) further prompts the user for information, namely, the order of execution, the repetition, the resetting, the batches which the test execution module (1d) uses for executing in the specified area. The result of each execution is updated to the said data storage means (2) and the completion of testing is informed to the user. The report module (1e) assists in generating the reports or the pseudo codes for specified test scenario.

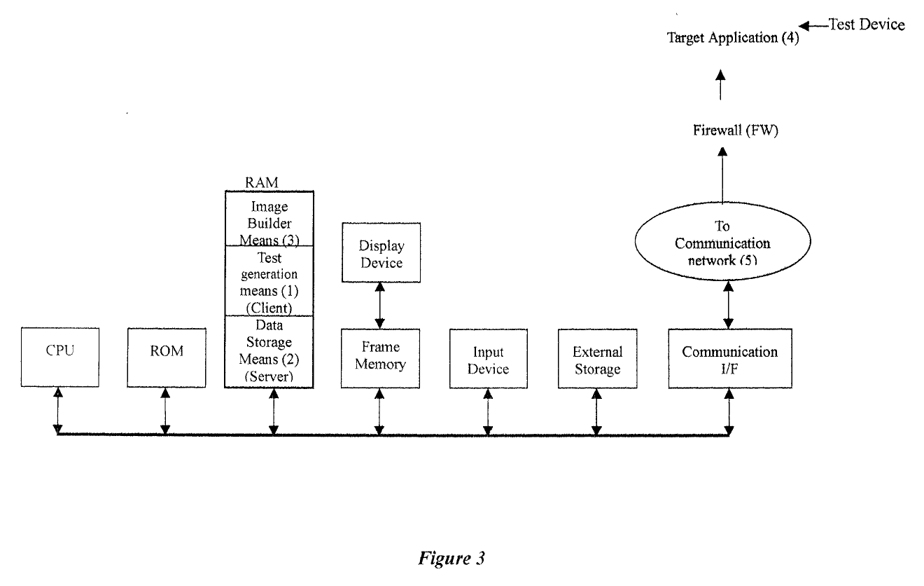

FIG. 3 shows a single computing device (CD) in which the entire automatic test generation system is implemented connected to target application (4) through communication network (5). The image builder means (3), test generation means (1) and data storage means (2) are all resident in the RAM of said computing system (CD). The said computing system executes all the functions of each module and communicates with the target application (4) over the communication network (5).

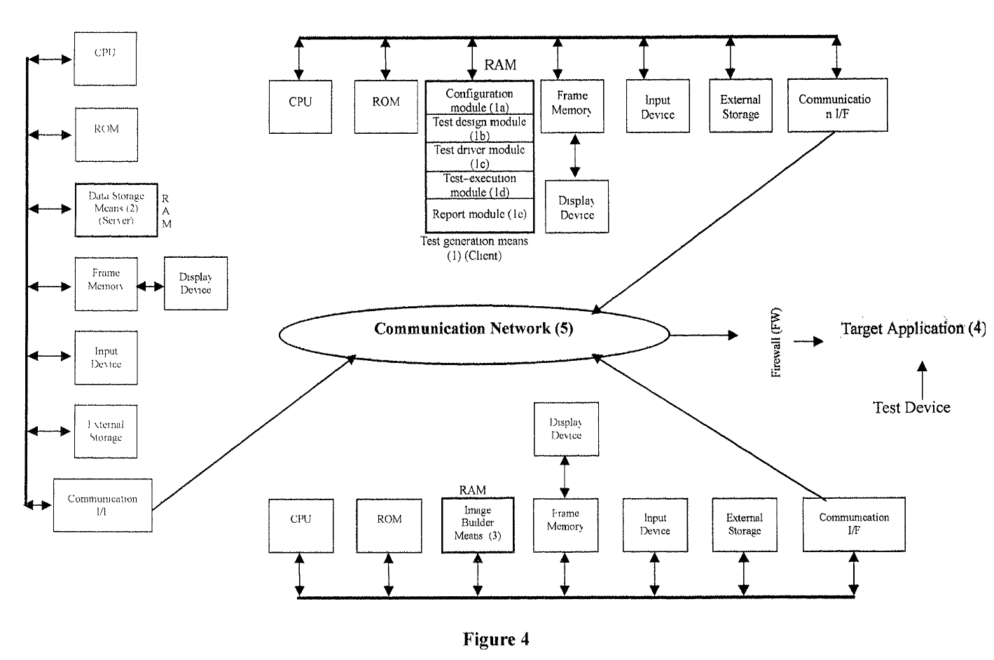

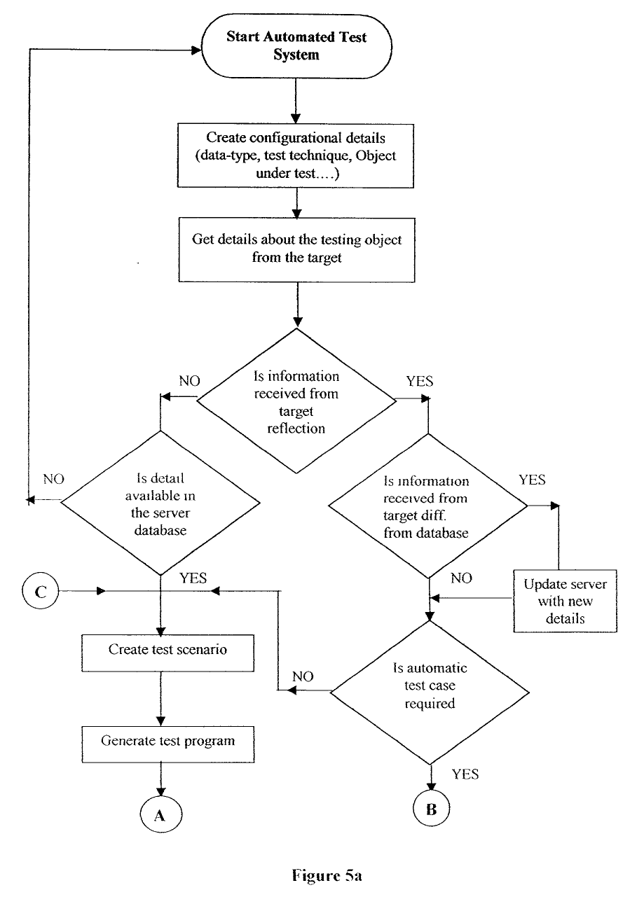

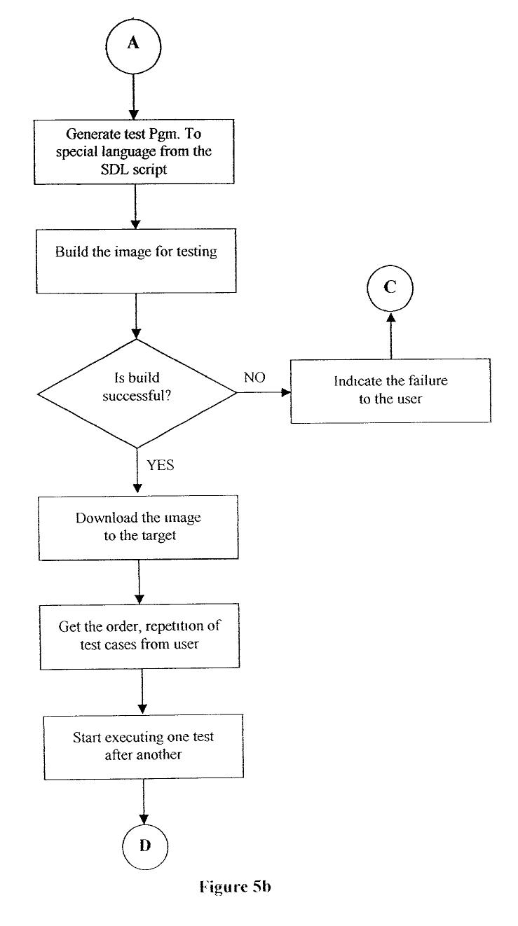

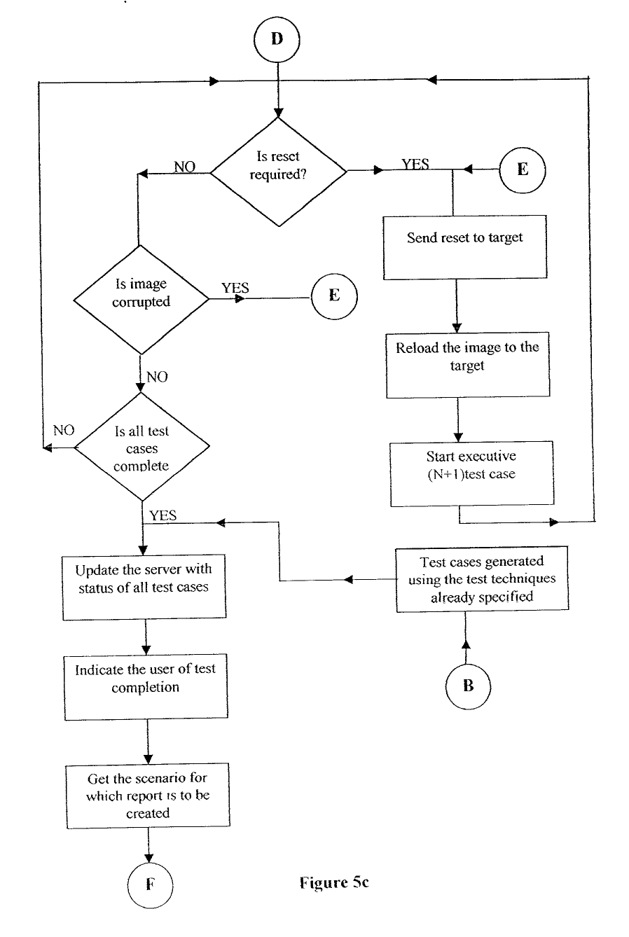

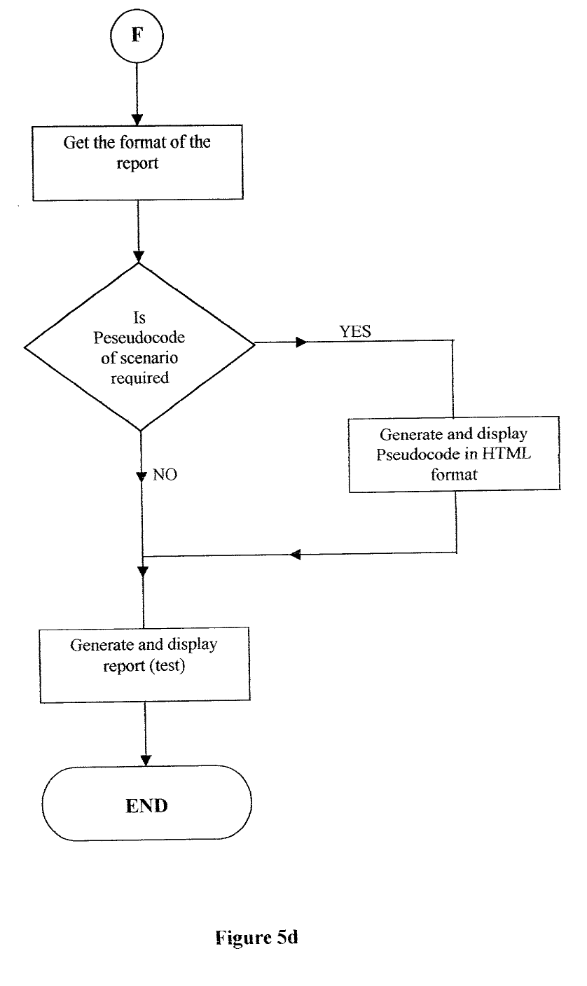

FIG. 4 illustrates an embodiment in which the automatic test system is implemented over three computing systems (CD1, CD2 & CD3) all connected to each other and to the target application (4) through a communication network (5). The computing system (CD1) contains the test generation means (client, 1), computing system (CD2) incorporates the data storage means (server, 2) and computing system (CD3) incorporates the image builder means (3). Each of the modules is resident in the RAM of the respective computing systems. The client on computing system (CD1) further consists of configuration module (1a), test design module (1b), test driver module (1c), test execution module (1d) and report module (1e), all resident in the RAM of computing system (CD1)

Referring to the functional flow of target application testing, as shown in FIGS. 5(a) to 5(d), which are self-explanatory, it may be seen that the user provides the automatic test system with details about data-types, test techniques, object details and other configurational details through the test generation means (1). The said test generation means (1) updates the said data storage means (2) with the user's information. Once the testing is initiated, the test generation means (1) uses the reflection principle to obtain meta-information about the target application for which it sends a reflection object to the target application (4). The information from the target is uploaded either by the said reflection object or by the built-in reflection object in the target application (4), to the test generation means (1). The test generation means (1) then checks the data storage means (2) for this meta-information. In case of mis-match, the data storage means (2) is updated by the test generation means (1). If no information from the target is received, then the data storage means (2) is searched for this information. If the information is not available in the data storage means (2) also, the user is required to provide fresh details about the target object details and other configurational details like new data types, test techniques etc., and the above steps are repeated.

If the user does not require automatic test case generation from the meta- information of the target application and execution then the test scenario framework is provided to create the test scenario. Using the test scenario, the test cases are automatically generated using the specified test techniques and the test program is generated in description language. The test program in description language to the desired language by means of a code converter. The converted program is then downloaded to the image builder for building the image for testing. If the building of image is successful, the image is downloaded to the target, otherwise the user is informed. The order of execution, repetition, resetting of the target applications is obtained from user and thereafter the tests are executed one after the other.

For each test program in case of problem while the test is executed, reset may be required. The problem may further result in corruption of the image. In such a case, the image is reloaded after performing the reset. Once all the tests have been executed, the results are updated on the data storage means.

If the user requires automated testing i.e., without creating the test scenario, the test cases are generated automatically using the test techniques specified for the data types of the target application, the test execution is performed and the results are updated on the data storage means.

User is informed of the completion of the testing. The user specifies the scenarios for which the reports are to be generated. The report format is obtained from the data storage means (server). If the user requires pseudocode of the scenario then the pseudocode is generated in HTML format. The final reports are generated and displayed to the user.

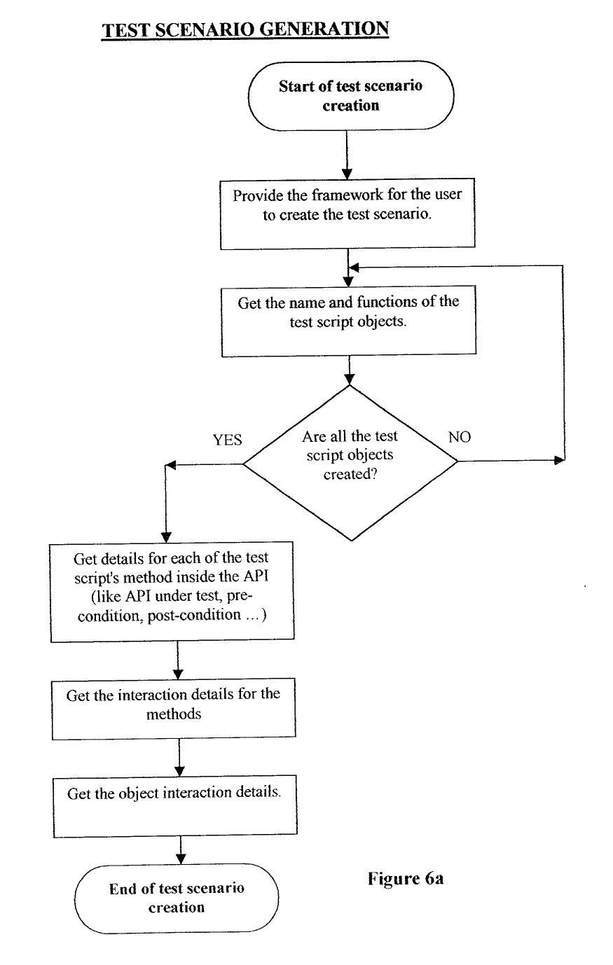

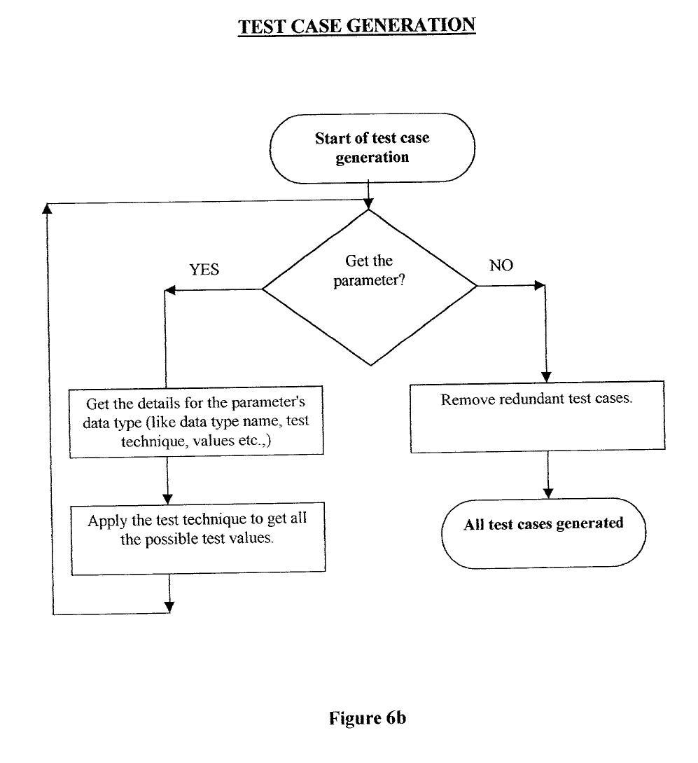

FIG. 6a is self-explanatory. For generation of test cases for the selected test scenario, the ATS system gets the parameter details viz like the parameter name, data-type details, test technique, etc., for each of the parameter defined for the selected object under test from the data storage means. By applying the specified test technique, all the possible test cases are generated. Once all the parameters have been processed in this manner, any redundant test cases are removed. The user is further provided with the list of test cases on which modification, deletion or addition of test cases could be done. Also the user could indicate the places of reset (i.e., after a specified test case) and the expected results could be added for each of the test cases. This completes the generation of test cases, which is then stored by the data storage means.

FIG. 6b is self-explanatory. To create the test scenario, the ATS system provides a framework for creating the test scenarios. The test scenario framework facilitates the user in providing the information like the details of the object under test, the pre-conditions, post-conditions etc. Then by using the framework, user shall also provide the test driver layout i.e., the test driver objects detail, its methods and method interaction and also the object interaction if any. Finally the test scenario information is then stored by the data storage means.

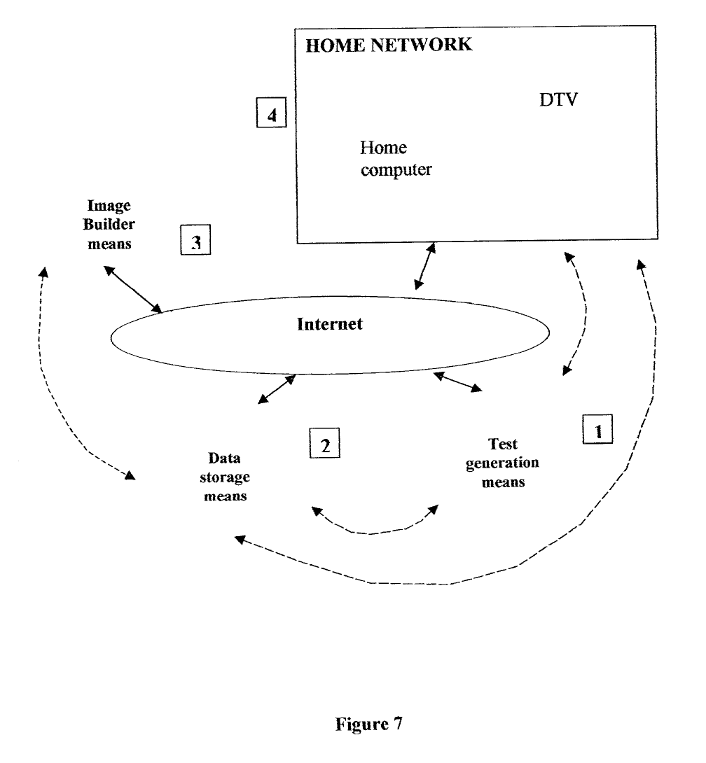

FIG. 7 shows the application of the automatic test system to a home network system incorporating a DTV. The test engineer (user) uses any of the test generation means (Client) (1) and indicates that the target application (4) is a DTV, which has to be tested. The target application (4) is on a remote site and the DTV is in operation.

The assumption for the DTV (4) that is to be tested is that, it does not require any user interaction during the course of its test execution phase.

Once the test engineer specifies the details of the DTV (4), the test generation means (1) sends the mReflect object which gets downloaded through the downloadable feature on the running DTV and then mReflect queries the meta information of that DTV (4). If the downloadable feature is not supported then the DTV is assumed to have the mReflect object also installed as part of the DTV and which can be initiated from the remote area whenever the testing is required. mReflect then gets the meta information of the DTV i.e., the information like the application object's name, interfaces and the interface details and indicates the meta details to the data storage means (server, 2). The server then searches to check if the DTV details are already configured, if not then this new information is configured.

Once the information about the DTV is known to the server, the image can be created by the test engineer (user) or the mReflect object can automatically create the test cases.

In case of the image creation, the test engineer (user) defines the test scenarios providing the appropriate pre-conditions, post conditions using the test scenario framework and the test cases are generated using the test techniques specified for each of the data types as described above. After the test cases are fine tuned by providing the expected value or the result, the test program is generated, the program is sent to the image builder means (3). Once the image is built, the image is downloaded to the DTV and the test application starts performing the testing.

If the option of automatic testing is chosen, then the mReflect object generates the test cases based on the parameter types of each of the methods of the DTV, the server is updated with the list of test case values and the test engineer (user) provides the expected set of values.

Once the test execution is in progress, the results of the execution are updated to the server and the end of test execution is indicated to the test engineer.

The test engineer at the remote site is able to get the report of the testing and the test results with the configured format.

It is possible to initiate simultaneous testing on multiple target applications from the test generation means (client). The target applications may further be at one location or at different locations remote from the client.

Reflection Principle:

The reflection principle used by the test generation means to obtain meta-information of the target application is achieved through the reflection feature provided by the environment like Aperios operating system (Sony's Realtime OS) or by Java.

A reflective object say ‘mReflect’ of the present invention is bundled or downloaded to the target application. The ‘mReflect’ at runtime queries the meta information of the application.

The meta information queried are:

the number of objects in the application

inspect the internals of an object

the name of the class

all the methods/interfaces within the class

Signature/parameters within the method etc,.

Furthermore the reflective object from the automated test system also captures the method calls to other objects within the image. It is also capable of invoking the required method/interface of the application. The mReflect object then updates the object under test (OUT) data in the data storage means with the configuration of the object under test.

In case of automatic testing, the mreflect object dynamically generates the test cases depending on the meta information received from the application by varying the values of the method parameters at run time (by applying the proven algorithms such as Boundary Value Analysis, Equivalence Partitioning or other configured techniques). The mReflect object then communicates the details of the test cases which are generated to test the object to the data storage means (SERVER) along with the details of the application or the object under test (i.e., the meta information of the object under test). Once the expected set of results are provided, the mReflect object starts testing the application and the results of the testing of the application are updated in the server. The meta information of the testing application, the test cases with the expected results and the results of the test execution are stored in the data storage means (server).

Since the reflection object assumes no boundaries or specification of the application before being bundled along with the image and gathers information about the same during the execution time, the test feature can be enabled for most kinds of object oriented applications.

The reflection object therefore is mobile and can migrate and adapt itself to its execution environment. Since the reflection object understands the application, which is under test, the time for configuring the details of the application is reduced considerably and is automated. Further, the reflection object automatically generates the test cases and hence the image need not be rebuilt, which eliminates the time for image building and downloading of the image and the use of the image building means like the compilers and the linkers.

If the application environment supports downloading feature, then the reflection object need not be bundled along with the application and is downloaded at the time of testing.

Object Serialization:

The data storage means uses the principle of object serialization in order to improve the performance of the testing activity. It does this by creating objects at run time and passing the created objects along with the state information to the point of use (test generation means, target applications) where it is put to use immediately. This saves the time for the creation of object at the point of use. Also since the communication over the network does not involve the use of text messages, as in normal internet communication, the security of the communication is enhanced. The serialized objects also initialized and they even undergo an initial execution phase at one end before being passed to another point on the network, where the execution continues from the point where it was initialized.

The advantage of this technique is to aid in the sharing and the use of the resources that are anywhere in the communication network.

Test Technique Independence at the API or Methods:

The existing testing tools require the test technique to be provided for each of the methods or the Application Programming Interfaces (APIs) which are to be tested.

The present invention overcomes the problem of repeating the test technique for each of the methods or APIs. Since each API/method has a different set of parameters, return type and different data type, configuring different test cases for each of the data types, is very cumbersome. Hence to generalize and ease the testing of APIs, the data types are configured to the Automated test system once. When the API/method is configured by indicating the parameter and the return type, the Automated test system will automatically generate the test cases for the APIs or the method. Test cases are generated based on the test technique types, which are specified while configuring the data type.

Some of the advantages of the design technique used by the present invention are:

1. It is possible to generate test cases for all APIs/method if all the parameters of the API/method fall under the category of basic data types or user defined special data types.

2. Since the data types will be taken as the basis to generate the test cases for the parameter of an API, the techniques like Equivalence partitioning (EP), Boundary value analysis (BVA), and Cause Effect Graphing techniques or any other specified techniques can be applied to the parameters and hence are not dependent on the API or the method for which the test case is generated.

3. Test cases are generated from a wide spectrum of test cases. Hence the testing is more exhaustive as different techniques are applied to each of the data types.

4. Since the test cases depend on data types, the information about the test technique to be used is fed to the Automated test system only once which reduces effort.

Automating Test Case Generation:

In the conventional testing, it is required that the tester is intelligent enough to provide sufficient number of test cases each with unique combination of values. It is important that while doing so the tester has provided at least a minimum number of test cases to check the APIs behavior in any scenario. It is quite possible that many of the test cases so created might be redundant in nature that is different test cases testing the same combination of parameters.

The present invention's approach overcomes the problem by automating the test case generation. This is based on varying the parameters of the API or the method under different combinations. Automated test case generation eases the task of the test engineer significantly. This is achieved by utilizing the test technique specified for the parameter's data type. The test techniques currently supported are Boundary Value Analysis (BVA), Equivalence Partitioning (EP) and Cause Effect Graphing (CEG). The Automated test system also has the provision to add new test techniques.

The present invention uses the data type specified test techniques and produces a set of valid and a set of invalid test case values. Subjecting the API/method to a combination of valid and invalid test case values results in number of valid and invalid test cases.

BVA aims at generating boundary values for the parameter, that is for each parameter, there are four possible test case values—the maximum value, the minimum value, one value just above the maximum value and a value just below the minimum value. The initial two are valid test cases values and last two invalid.

In the case of Equivalence partitioning, each parameter range is split into two or more sub-ranges. Each of sub-ranges should identify one valid value and two invalid values. The mid range value is preferably the valid value (min<value<max), the invalid values are generated by initially calculating a ‘epsilon’, e and then two invalid values are (min−e) and (max+e). As a result three test case values are obtained for each sub-range.

However in the case of cause effect graphing, the test cases are narrowed to the error prone areas by further grouping logically thereby optimizing types and number of effective test cases. The test engineer specifies the group for the parameter and the test cases are generated taking test values from all possible groups and applying the test technique for each of the logical group.

For each parameter considered at a time, all the possible values is generated depending upon the test technique chosen. Then by varying values of individual parameter on at a time, finite number of test cases are generated. While doing so the combinations are checked for redundancy if any and are appropriately filtered.

Note that for proper test -cases to be generated, it is important that all the data types are specified correctly with the limits specified accurately. Hence prior to the API specification this section of the design of the invention assumes that the data type details are specified to the Automated test system.

For example consider an API say function,

Boolean foo(int param1,float param2,boolean param3)

Considering a single parameter at a time,

param1 being a integer type having range from 0 to 100 and the test technique selected being BVA, the possible test case values are 0,100,−1,101

param2 being a float type having range from 0.00 to 1000.00 and the test technique chosen being BVA, initially calculate epsilon ‘e’=0.01 based on number of decimal places.

So test case values possible are 0.00, 1000.00, −0.01,1000.01

param3 being Boolean having only two test case values, the test technique chosen being EP produces TWO possible values: true, false.

Each of test case values thus generated can be passed to the function foo with varying degrees of combination. Some of the possible test cases are:

foo(0,0.00,true)

foo(−1,0.00,true)

. . .

foo(0,−0.0 1,true)

foo(0,1000.00,true)

foo(0,0.00,false)

foo(−1,0.00,false) . . . etc.

Hence, the test cases can be generated through varying of parameters automated by applying test technique thereby greatly reducing the effort required by the test engineer. The test engineer is provided with an additional option to select groups of values of parameters for which the API or the method behaves the same using CEG and different test technique being adopted for each of the groups. The Automated test system shall produce the appropriate combination of test cases for each of the groups.

Automated Test Execution:

The present invention (Automated Test System) greatly aids in automating the test execution phase of the testing. The automation is from the stage of image loading until the complete execution of the testing.

The test engineer configures the object details and then selects the image and the application area on which it has to be downloaded and tested. The automated test system then automatically loads the application on the target system (Target application) and execution is started. Once the image is loaded, the execution begins. The result of the execution is captured by the system, checked with the expected set of values and appropriate inferences are made against each of the test cases and the data storage means is updated with this data.

While in test execution mode, the test engineer (user) is able to further specify the subset of test scenarios from the set of scenarios upon which the image is built. The system provides for specifying the order of testing, resetting of the object at any point of the execution say after nth test case, reloading of the image and even for any repetition without changing or rebuilding of the image.

The test engineer (user) is able to interrupt the execution at any point in the middle of the execution. The test execution part of the system also provides the support for reloading and executing from the place where the previous testing was halted, incase the testing was stopped at the middle of the execution.

Additional features like specifying execution of a group of test cases based on the result of a certain set of test cases or the use of an alternate set of test cases, are provided.

The test execution assumes that the target system (where the test is to be executed) is accessible through the network.

Independence of Test Reporting:

The existing systems have the feature of either taking the reports from the test center or the system mails the results of the testing to the specified location. Mailing the test results requires the target system to have a mailing server. However, in this situation it is difficult to produce different formats of reports.

In the present invention, the results of the testing are stored in the data storage means. The data is accessible by any of the clients that are connected to this network. Since the configuration, test scenarios, test results are transparent to all the clients, the test reporting can be taken independent of the test location and also with the required format including HTML format.

The application in this particular implementation is on a set of software including our operating system

### DEFINITIONS

Test case: A unique set of values or conditions that are applied to the testing element.

Test scenario: A particular sequence of performing the test, like setting a set of pre-condition before actually conducting the test.

Test program: A program, which shall drive the testing element with the different test cases. The test cases are called as defined in the scenario i.e., certain conditions are set before calling the test cases and certain conditions are set either after each test case or at the end of all the test cases as specified in the test scenario.

Test technique: Technique to select a subset of test cases, which covers most of the ranges. Different test techiques are available like the Equivalence partioning, Boundary value analysis, Cause effect graphing etc.,

Test program consists of

{test scenario, where test scenario consists of

(pre-condition,
test cases, which are generated based on the test technique.

post conditions)}

ODBC/JDBC: Stands for Object DataBase Connectivity/Java DataBase Connectivity. They provide a set of standard interfaces to interact with the database.

1-37. (Canceled)

38. A method for testing remote target applications, said method comprising the steps of:
obtaining meta-information of a target application;
comparing the obtained meta-information with pre-stored meta-information;
updating the pre-stored meta-information when a discrepancy between the obtained meta-information and the pre-stored meta-information is detected;
automatically generating test cases based on the obtained meta-information;
automatically creating test scenarios;
generating the test cases from the test scenarios;
automatically generating test programs using the test scenarios and the test cases;
building a test image from the test programs;
downloading the test image to the target application for testing;
automatically testing the target application;
generating reports from test results in a desired format;
providing a framework to define the test scenarios by using the obtained meta-information;
automatically generating different test cases using the test scenarios; and
generating the test programs in a description language using the test scenarios and the test cases.

39. The method as claimed in claim 38, wherein
the meta-information of the target application are obtained by using a reflection principle in one of two ways; (i) by utilizing a reflection object bundled with the target application or (ii) by downloading the reflection object to the target application.

40. The method as claimed in claim 38, wherein
the test scenarios, the test programs and the test image are generated by utilizing object serialization in order to improve data communication security over a network, as well as to improve utilization of resources in the network in order to reduce time of execution.

41. The method as claimed in claim 38, wherein
the test programs are generated independently of the Application Programming Interfaces (APIs).

42. The method as claimed in claim 38, wherein
execution of the test programs is conducted by a user utilizing an order of execution, a repetition, a requirement for resetting and batch information.

43. The method as claimed in claim 38, wherein
the reports are generated for each specified test scenario.

44. The method as claimed in claim 38, wherein
a solution is provided to a service station for testing the target application or the service station utilizes an automatic test system through a terminal provided at the service station.

45. The method as claimed in claim 38, wherein
a plurality of target applications are simultaneously tested either at one location or at multiple locations.

46. The method as claimed in claim 38, wherein
the framework is a Boolean foo function which results in regular testing and irregular testing.

47. The method as claimed in claim 46, wherein
the regular testing is a Boundary Value Analysis (BVA) technique that includes a parameter being an integer type having a range between 0 and 100.

48. The method as claimed in claim 46, wherein
the regular testing is a Boundary Value Analysis (BVA) technique that includes a parameter being a float type having a range between 0 and 1000.

49. The method as claimed in claim 46, wherein
the regular testing is a Equivalence Partitioning (EP) technique that includes a Boolean having only two test case values.

50. The method as claimed in claim 38, wherein
resetting is performed when a user determines that the test programs contain execution errors.

51. The method as claimed in claim 38, wherein
the remote target applications are identified with an Internet Protocol (IP) address.

52. An automatic test system for testing remote target applications, said system comprising:
obtaining means for obtaining meta-information of a target application;
comparing means for comparing the obtained meta-information with pre-stored meta-information stored in a storage means;
updating means for updating the pre-stored meta-information when a discrepancy between the obtained meta-information and the pre-stored meta-information is detected;
first generating means for automatically generating test cases based on the obtained meta-information;
test scenario creating means for automatically creating test scenarios;
second generating means for generating the test cases from the test scenarios;
third generating means for automatically generating test programs using the test scenarios and the test cases;
image builder means for building a test image from the test programs;
downloading means for downloading the test image to the target application for testing;
testing means for automatically testing the target application;
fourth generating means for generating reports from test results in a desired format;
providing means for providing a framework to define the test scenarios by using the obtained meta-information;
fifth generating means for automatically generating different test cases using the test scenarios; and
sixth generating means for generating the test programs in a description language using the test scenarios and the test cases.

53. The automatic test system as claimed in claim 52, wherein
the meta-information of the target application is obtained by using a reflection principle by utilizing a reflection object bundled with the target application.

54. The automatic test system as claimed in claim 52, wherein
the meta-information of the target application is obtained by using a reflection principle by downloading a reflection object to the target application.

55. The automatic test system as claimed in claim 52, wherein
the test scenarios, the test programs and the test image are generated by utilizing object serialization in order to improve data communication security over a network, as well as to improve utilization of resources in the network in order to reduce time of execution.

56. The automatic test system as claimed in claim 52, wherein
the test programs are generated independently of the Application Programming Interfaces (APIs).

57. The automatic test system as claimed in claim 52, wherein
execution of the test programs is conducted by a user utilizing an order of execution, a repetition, a requirement for resetting and batch information.

58. The automatic test system as claimed in claim 52, wherein
the reports are generated for each specified test scenario.

59. The automatic test system as claimed in claim 52, wherein
a solution is provided to a service station for testing the target application or the service station utilizes an automatic test system through a terminal provided at the service station.

60. The automatic test system as claimed in claim 52, wherein
a plurality of target applications are simultaneously tested either at one location or at multiple locations.

61. The automatic test system as claimed in claim 52, wherein
the framework is a Boolean foo function which results in regular testing and irregular testing.

62. The automatic test system as claimed in claim 61, wherein
the regular testing is a Boundary Value Analysis (BVA) technique that includes a parameter being an integer type having a range between 0 and 100.

63. The automatic test system as claimed in claim 61, wherein
the regular testing is a Boundary Value Analysis (BVA) technique that includes a parameter being a float type having a range between 0 and 1000.

64. The automatic test system as claimed in claim 61, wherein
the regular testing is a Equivalence Partitioning (EP) technique that includes a Boolean having only two test case values.

65. The automatic test system as claimed in claim 52, wherein
resetting is performed when a user determines that the test programs contain execution errors.

66. The automatic test system as claimed in claim 52, wherein
the remote target applications are identified with an Internet Protocol (IP) address.

67. The automatic test system as claimed in claim 52, wherein
the first generating means further comprises a configuration module, a test design module, a test driver module, a test execution module and a report module that are connected to the storage means via a network.

68. The automatic test system as claimed in claim 67, wherein
the configuration module is a software program executed on a computing system that obtains information on test techniques, objects and data types from a user for defining the test cases.

69. The automatic test system as claimed in claim 67, wherein
the test design module is a software program executed on a computing system that provides the framework of the test scenarios.

70. The automatic test system as claimed in claim 67, wherein
the test driver module is a software program executed on a computing system that automatically generates the test cases and the test programs in the description language by utilizing the test scenarios provided by the test design module.

71. The automatic test system as claimed in claim 67, wherein
the execution module loads the test image created by an image builder module on the target application, and monitors and controls the execution of the test image of the target application.

72. The automatic test system as claimed in claim 52, wherein
the image builder means converts the test programs received from the test driver module in the description language to an image form suitable for loading and executing on the target application.

73. The automatic test system as claimed in claim 67, wherein
the report module generates reports from the results of the testing on the target application, which are stored in the data storage means.

74. The automatic test system as claimed in claim 52, wherein
the data storage means stores information relating to a test scenario, a test technique, an object, results of tests and incorporates object serialization means in order to improve execution time and security.

75. The automatic test system as claimed in claim 52, wherein
the testing means is developed in a programming language that is hardware and software independent.

76. The automatic test system as claimed in claim 52, wherein
the description language is Standard Description Language (SDL).

77. The automatic test system as claimed in claim 52, wherein
the description language is converted by a language code converter to a desired test language.

78. The automatic test system as claimed in claim 77, wherein
the language code converter converts a description language test program to a desired language test program that is provided either at the test driver module of the test generation means or at the image builder means.

79. The automatic test system as claimed in claim 52, wherein
the data storage means is a server and is not dependent on any particular database, the server being developed in a programming language that is hardware and software independent.

80. The automatic test system as claimed in claim 52, wherein
the image builder means comprises a compiler and a linker in order to generate an executable data image.

81. The automatic test system as claimed in claim 52, wherein
the testing means further includes a means for simultaneously testing a plurality of target applications at one location or at multiple locations.

82. The automatic test system as claimed in claim 52, wherein
a fire-wall is either provided between the testing means and a network or between the communication network and the target applications or at both locations for access control.
